(19) United States
(12) Patent Application Publication
(10) Pub. No.: US 2025/0158715 A1
(43) Pub. Date: May 15, 2025

(54) CHANNEL MANAGEMENT

(71) Applicant: Micron Technology, Inc., Boise, ID (US)

(72) Inventors: Saideep Tiku, Fort Collins, CO (US); Poorna Kale, Folsom, CA (US); Febin Sunny, Folsom, CA (US)

(21) Appl. No.: 18/934,961

(22) Filed: Nov. 1, 2024

Related U.S. Application Data
(60) Provisional application No. 63/598,411, filed on Nov. 13, 2023.

(51) Int. Cl. H04B 10/27; H04Q 11/00

(52) U.S. Cl. CPC H04B 10/27; H04Q 11/0062; H04Q 2011/0086

(57) ABSTRACT

Systems, methods, and apparatuses related to channel management are described herein. An optical communication system can comprise an optical source configured to send optical signals, a meta-waveguide having a limited quantity of channels, the meta waveguide coupled to the optical source and configured to transport the optical signals, and a controller coupled to the optical source and the meta-waveguide, the controller configured to determine a type of data to be sent via the meta-waveguide, cause optical signals indicative of the data to be sent through at least one of the channels, and cause a gap comprising at least one unutilized channel to be reserved between the at least one channel and another utilized channel depending on the type of data.

### PRIORITY INFORMATION

This application claims the benefit of U.S. Provisional Application No. 63/598,411, filed on Nov. 13, 2023, the contents of which are incorporated herein by reference.

### TECHNICAL FIELD

The present disclosure relates generally to apparatuses, systems, and methods associated with channel management for data within a network.

### BACKGROUND

A computing device can be, for example, a personal laptop computer, a desktop computer, a smart phone, smart glasses, a tablet, a wrist-worn device, a mobile device, a digital camera, network server, a vehicle, and/or redundant combinations thereof, among other types of computing devices.

Computing devices can be used to perform operations. Performing operations can include communicating with other devices and/or systems, for example. Communicating with other devices and/or systems can utilize resources of the computing devices. Performing operations can utilize memory resources, processing resources, and power resources, for example.

### BRIEF DESCRIPTION OF THE DRAWINGS

FIG. 1 illustrates an example computing system that includes a memory sub-system in accordance with some embodiments of the present disclosure.

FIG. 2 illustrates a network for channel management in accordance with some embodiments of the present disclosure.

FIG. 3 is a flow diagram illustrating a method for using a channel management tool in accordance with some embodiments of the present disclosure.

FIG. 4 illustrates an example of a system including a computing system in a vehicle in accordance with some embodiments of the present disclosure.

FIG. 5 is a block diagram of an example computer system in which embodiments of the present disclosure may operate.

### DETAILED DESCRIPTION

The present disclosure includes apparatuses, methods, and systems associated with channel management for data within a network. Recent automotive applications have a large number of low-complexity Electronic Control Units (ECU) connected over a bus operated according to a standard such as a controller area network (CAN), FlexRay, or media oriented systems transport (MOST). However, automotive applications and platforms are headed towards high-bandwidth low-latency communication across fewer high-complexity compute nodes. Future automotive platforms may consist of fewer high-performance compute and memory devices that are able to deliver level three or greater (L3+) advanced driver assistance system (ADAS) features on demand. The on-demand aspect of automotive workloads may lead to large variations in data movement across communication channels, that might lead to higher jitter rates. Jitter is the deviation from true periodicity of an intended periodic signal (either carrier or sub-carrier), which may be caused by interference and/or crosstalk with carriers of other signals. Crosstalk is a phenomenon by which a signal transmitted on one channel creates an undesired effect in another channel. As such, the disclosure herein describes a crosstalk-aware time-sensitive network for automotive platforms that employs meta-photonic waveguides and dynamic allocation of channels (waveguide sub-carriers). The meta-waveguide consists of a limited number of sub-carrier channels. As described herein, a group of processes associated with a specific functional aspect of the automotive platform can be assigned one or more channels in the waveguide. The channels are allocated such that a gap is created between utilized channels. The gap provided by unutilized channels is maximized based on the function and priority of the data which enables a reduction in crosstalk.

In cases where channels need increased crosstalk protection, such as cases where channels are assigned to critical cases, the micro-ring resonators, which modulate the channels can be electro-optically tuned so that the channel selection is shifted, enabling higher channel-gaps, at the expense of increased energy consumption. Further, that gap between channels can be optimized to ensure safety and reliability of the system. For example, a channel carrying highly sensitive information that may affect the safety of the passengers, such as ADAS, is channel-gapped from other non-critical applications. Moreover, with this embodiment, the applications experiencing higher jitter can be allocated additional channels, effectively doubling the bandwidth available to the process.

An embodiment includes a network that comprises a channel management device and a processing device. The channel management device can be configured to allocate a subset of channels for sending data, reserving a gap between channels utilized for sending data, and sending data on an allocated channel within a subset of channels. The channel management device can be communicatively coupled to a computing system and configured to reduce crosstalk by reserving gaps between data that is to be sent through the channels in the network.

Embodiments of the present disclosure can decrease and/or prevent crosstalk when sending optical signals through channels. An optical communication system can include an optical source configured to send optical signals, a meta-waveguide having a limited quantity of channels, the meta waveguide coupled to the optical source and configured to transport the optical signals, and a controller coupled to the optical source and the meta-waveguide, the controller configured to determine a type of data to be sent via the meta-waveguide, cause optical signals indicative of the data to be sent through at least one of the channels, and cause a gap including at least one unutilized channel to be reserved between the at least one channel and another utilized channel depending on the type of data.

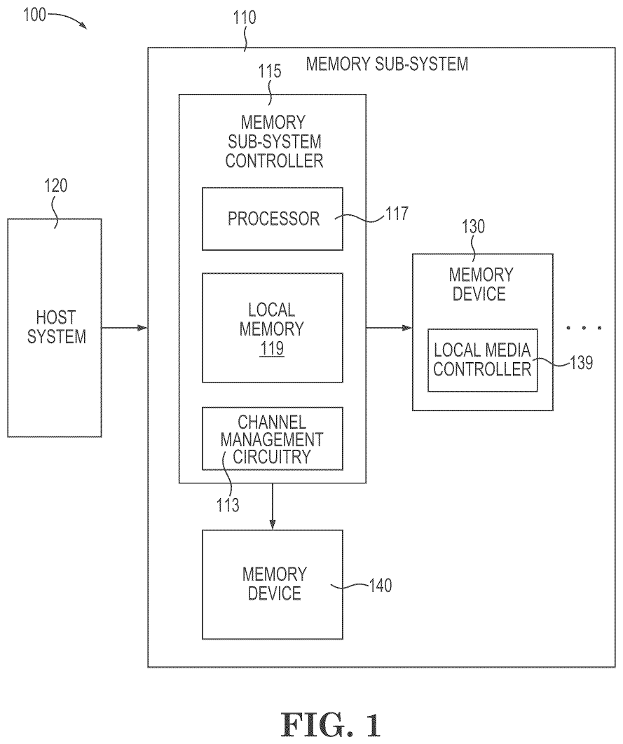

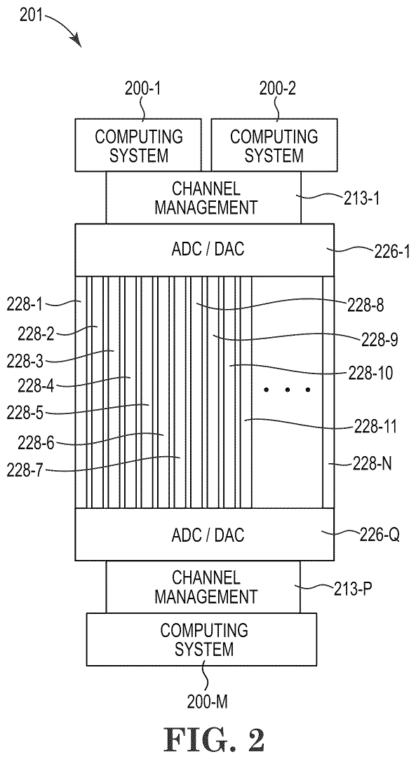

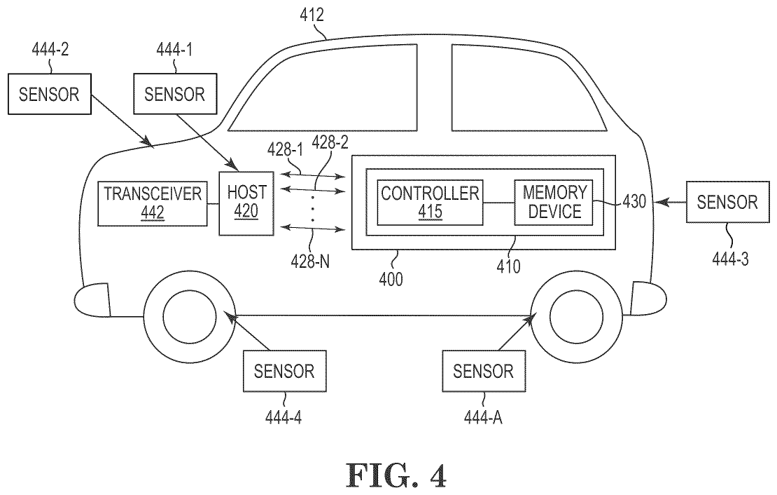

The figures herein follow a numbering convention in which the first digit or digits correspond to the figure number of the drawing and the remaining digits identify an element or component in the drawing. Similar elements or components between different figures may be identified by the use of similar digits. For example, reference numeral 115 may reference element “15” in FIG. 1, and a similar element may be referenced as 415 in FIG. 4. Multiple analogous elements within one figure may be referenced with a reference numeral followed by a hyphen and another numeral or a letter. For example, 200-1 may reference element 200-1 in FIGS. 2 and 200-2 may reference element 200-2, which may be analogous to element 203-1. Such analogous elements may be generally referenced without the hyphen and extra numeral or letter. For example, elements 200-1, 200-2, and/or 200-M or other analogous elements may be generally referenced as 200.

As used herein, “a,” “an,” or “a number of” can refer to one or more of something, and “a plurality of” can refer to two or more such things. For example, a memory device can refer to one or more memory devices, and a plurality of memory devices can refer to two or more memory devices. Additionally, the designator “A,” “M,” “N,” “P,” “Q,” etc. as used herein, particularly with respect to reference numerals in the drawings, indicates that a number of the particular feature so designated can be included with a number of embodiments of the present disclosure.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 can be coupled to different types of memory sub-systems 110. FIG. 1 illustrates one example of a host system 120 coupled to one memory sub-system 110. As used herein, the term “coupled to” or “coupled with” can refer to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via an interface (e.g., a physical host interface). Examples of an interface can include, but are not limited to, a serial advanced technology attachment (SATA) interface, a peripheral component interconnect express (PCIe) interface, universal serial bus (USB) interface, Fibre Channel, Small Computer System Interface (SCSI), Serial Attached SCSI (SAS), a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), Universal Serial Bus (USB), or any other interface. The interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the PCIe interface. The interface can provide a way for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as NAND type memory (e.g., 2D NAND, 3D NAND) are described, the memory device 130 can be based on any other type of non-volatile memory or storage device, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g. processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface (not pictured) circuitry to communicate with the host system 120 via a physical host interface (not pictured). The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140.

In some embodiments, the memory device 130 includes local media controllers 139 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 139) for media management within the same memory device package. An example of a managed memory device is a managed NAND (MNAND) device.

In some embodiments, the memory sub-system controller 115 can include channel management circuitry 113. The memory sub-system controller 115 can use the channel management circuitry 113 to send optical signals indicative of the data through at least one of the channels within a vehicle based on a channel management model stored in a memory device 130, 140. The memory sub-system controller 115 can further use the channel management circuitry 113 to cause a gap including at least one unutilized channel to be reserved between an utilized channel and another utilized channel depending on the type of data based on a channel management model stored in the memory device 130, 140.

FIG. 2 illustrates a network 201 for channel management circuitry 213 in accordance with some embodiments of the present disclosure. The network 201 comprises a computing device (e.g., computing system 200) including a memory device to send data through channels. For instance, an optical communication system (e.g., computing system 200) can include an optical source (e.g., sensor 444 of FIG. 4) to send optical signals. The optical signals can be sent via a meta-waveguide having a limited quantity of channels 228. The computing system 200 can cause data from multiple optical sources to be sent across the meta-waveguide including communication channels 228. The meta-waveguide including channels 228 can be coupled to an optical source through the computing system 200. The computing system 200 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

In some embodiments, the controller (e.g., controller 415 of FIG. 4) can be coupled to the optical source and the meta-waveguide. The controller can cause the channel management circuitry 213 to determine the type of data being sent through the channels 228 of the meta-waveguide. The data sent can have different attributes, such as, different priority levels, different functions, and/or different amounts, etc. The channel management circuitry 213 can use the different attributes to determine the type of data being sent through the channels 228 of the meta-waveguide. Further, the controller can cause an optical signal indicative of the data to be sent through at least one of the channels 228 of the meta-waveguide via the channel management circuitry 213. The computing system 200 can use the channel management circuitry 213 to send data by allocating channels 228 for sending the data. In some embodiments, the channel management circuitry 213 can be a micro-ring resonator that selects channels for activity and inactivity. For instance, the channel management circuitry 213 can determine a subset of channels dedicated to sending the optical signals through the channels 228. For example, the channel management circuitry 213 can decide which channels 228 will be utilized for sending data and which channels 228 will be unutilized to create a buffer between channels utilized for sending data. As described herein, the controller, through the channel management circuitry 213, can cause a gap including at least one unutilized channel 228 to be reserved between the utilized channel 228 and another utilized channel 228.

In some embodiments, before the channel management circuitry 213 sends the data through the channels 228, the channel management circuitry 213 can send the optical signal through a converter 226. For example, if the optical signal is a digital signal, the converter 226 can convert the optical signal to an analog signal (the converse is also true). In some embodiments, a first device (e.g., first computing system 200-1) can generate data to be sent to another device (e.g., third computing system 200-M). The first computing system 200-1 can use a first channel management circuitry 213-1 to designate channels 228 to send the data to the third computing system 200-M. The first channel management circuitry 213-1 can cause the optical signal to be sent through a first converter 226-1 before allocating channels 228 to send the optical signal. The optical signal can then be received by a second converter 226-Q before sending the data to the third computing system 200-M on the opposite end of the channels 228. Similarly, the third computing system 200-M can send data through a second channel management circuitry 213-P and through the second converter 226-Q. The second management circuitry 213-P would allocate channels 228 to send the data via optical signal to a second computing system 200-2. The converter 226 can perform the opposite ADC/DAC function when receiving data. For example, if analog-to-digital conversion was performed prior to sending the signals, then digital-to-analog conversion can be performed after receiving the signals.

The controller can cause the channel management circuitry 213 to assign a subset of the channels 228 to a specified function. The channel management circuitry 213 may allocate the optical signal based on the function of the data. In some embodiments, each function may be assigned a different subset of channels 228 to send data through. In a non-limiting example, if the first computing system 200-1 and second computing system 200-2 were embedded computers included in a vehicle, the first computing system 200-1 can have the function of communicating to the brakes of the vehicle while the second computing system 200-2 can have the function of communicating with the seats of the vehicle. As such, the channel management circuitry 213 can assign each subset of channels 228 to respective functions (e.g., brakes and seats). Further, the channel management circuitry 213 can cause a different gap to be reserved between each of the plurality of subsets of the channels 228 depending on the respective type of data associated with the respective function. In some embodiments, the gap can be made up of all unutilized channels 228.

For instance, the first channel management circuitry 213-1 can allocate channels 228-1, 228-2, 228-3, 228-4, and 228-5 to the function assigned to the first computing system 200-1. In addition, the first channel management circuitry 213-1 can allocate channel 228-10 to the function assigned to the second computing system 200-2. In some embodiments, the type of function can determine the amount of channels the channel management circuitry 213 will allocate to the function and/or computing system 200 that sends the data associated with the function. For example, a function that has a high priority level may be allocated more channels 228 than a function that has a low priority level. In reference to the previous example, communicating with the brakes of a vehicle may be an extremely important function, as the brakes deal with the safety of the vehicle, passengers, and items in the vehicle. In comparison, communicating with the seats of the vehicle may not be as important as communicating with the brakes. The function of the first computing system 200-1 may have a higher priority than the function of the second computing system 200-2. As such, the first channel management circuitry 213-1 may allocate more channels 228-1, 228-2, 228-3, 228-4, and 228-5 (e.g., five channels) to the function of the first computing system 200-1, in comparison to the channel 228-10 (e.g., one channel) allocated to the function of the second computing system 200-2.

In some embodiments, the channel management circuitry 213 may allocate channels to data based on the amount of the data. The channel management circuitry 213 can send optical signals through one channel 228 or multiple channels 228 depending on the amount of the data being sent. Increasing the number of channels 228 used to send data can increase the bandwidth available to transmit the data and reduce the time delay between the time the signal is sent and received, as compared to using one channel 228 to send data of equal or greater amount. In addition, depending on the priority level of the data, sending the data through multiple channels may be useful in reducing time delay. This allows the data to get to the intended target faster, as compared to sending the data through a single channel 228.

In some embodiments, the channel management circuitry 213 may determine a subset of channels 228 to send data. The quantity of channels in the subset of channels 228 can depend on the attributes of the data, for example, the priority level of the data, the amount of the data, the function of the data, etc. For instance, if sending the data through a single channel has an increased chance of crosstalk and/or give a higher chance of jitter, the channel management circuitry 213 may send the data with two or more channels 228 to reduce the chances of crosstalk and/or jitter. Each channel 228 used to send the optical signal to another platform is a part of a subset of channels 228 assigned by the channel management circuitry 213.

The subset of channels 228 can include utilized channels 228 (e.g., channels used to send optical signals indicative of data) and/or unutilized channels (e.g., channels not used to send optical signals indicative of data). In some embodiments, the channel management circuitry 213 can use the unutilized channels to create a gap between channels that are carrying optical signals from a first data source and optical signals from a second data source. For example, the first subset of channels can include channels 228-1, 228-2, 228-3, 228-4. The first channel 228-1, in the first subset of channels can be used to send the first optical signal indicative of the first data. The channel management circuitry 213 can reserve channels 228-2, 228-3, 228-4 to create a gap between the first channel 228-1 being utilized to send the optical signal and another utilized channel 228 (e.g., channel 228-5) in a second subset of channels 228.

In some embodiments, the size of the reserved gap can depend on the priority level of the data. The channel management circuitry 213 can increase or decrease (e.g., reduce and/or eliminate) the amount of channels in a gap based on the priority level of the data. For example, the channel management circuitry 213 can increase the gap between utilized channels when the priority level of the data being sent through at least one of the utilized channels is high and decrease the gap (e.g., reduce and/or eliminate) if the priority level of the data being sent through at least one of the utilized channels is low.

The channel management circuitry 213 can allocate channels for sending data in a manner that reduces jitter and crosstalk to uphold the integrity of the data being sent, as compared to sending data on any available channel. In a non-limiting example, the channel management circuitry 213 can receive data at different and/or similar priority levels. For instance, the channel management circuitry 213 can receive first data with a high priority level, second data with a low priority level, and third data with a low priority level. The channel management circuitry 213 can assign a subset of channels 228 for each data before sending the data through the channels. Based on the priority level, the channel management circuitry 213 can reserve gaps between the utilized channels 228 to prevent jitter and crosstalk. For instance, the channel management circuitry 213 can assign a first subset of channels for the first data including channels 228-1, 228-2, 228-3, 228-4, and 228-5, a second subset of channels for the second data including channel 228-6, and a third subset of channels for the third data including channel 228-7. The channel management circuitry 213 can then reserve channels 228-2, 228-3, 228-4, and 228-5 as a gap while sending an optical signal indicative of the first data through channel 228-1. The channel management circuitry 213 can further send the optical signal indicative of the second data on channel 228-6 and the optical signal indicative of the third data on channel 228-7. Since the priority level for the first data is high (e.g., based on the function of the data, etc.) the channel management circuitry 213 may can create a buffer between the utilized channel sending the first data and the utilized channels sending the second and third data to prevent crosstalk and/or jitter from affecting the first data.

In another non-limiting example, the channel management circuitry 213 can receive first data with a high priority level, second data with a high priority level, and third data with a low priority level. The channel management circuitry 213 can assign a first subset of channels for the first data including channels 228-1, 228-2, 228-3, and 228-4, a second subset of channels for the second data including channel 228-5, 228-6, 228-7, 228-8, 228-9 and a third subset of channels for the third data including channel 228-10. The channel management circuitry 213 can then reserve channels 228-2, 228-3, and 228-4, as a gap while sending an optical signal indicative of the first data through channel 228-1. The channel management circuitry 213 can further reserve channels 228-6, 228-7, 228-8, and 228-9 as a gap and send the optical signal indicative of the second data on channel 228-5. Last, the channel management circuitry 213 can send the optical signal indicative of the third data on channel 228-10. Creating a gap for the first data and the second data can prevent crosstalk and/or jitter when sending the first data and the second data, which can help preserve the integrity of the high priority data being sent.

In yet another non-limiting example, the channel management circuitry 213 can receive first data with a high priority level, second data with a high priority level, and third data with a medium priority level. The channel management circuitry 213 can assign a first subset of channels for the first data including channels 228-1, 228-2, 228-3, and 228-4, a second subset of channels for the second data including channel 228-5, 228-6, 228-7, 228-8, 228-9 and a third subset of channels for the third data including channels 228-10, 228-11, and 228-N. The channel management circuitry 213 can then reserve channels 228-2, 228-3, and 228-4 as a gap while sending an optical signal indicative of the first data through channel 228-1. The channel management circuitry 213 can further reserve channels 228-6, 228-7, 228-8, and 228-9 as a gap and send the optical signal indicative of the second data on channel 228-5. Last, the channel management circuitry 213 can send the optical signal indicative of the third data on channel 228-10 while reserving channels 228-11 and 228-N. The buffer space between the utilized channels 228-1, 228-5, and 228-10 can assist with preventing crosstalk and/or jitter when data is sent through the network 201. In this example, the first and second data are considered high priority, but the reserved gap for each data is different. While the first and second data may be of a high priority, the second data may be of higher priority than the first as evidenced by the larger gap.

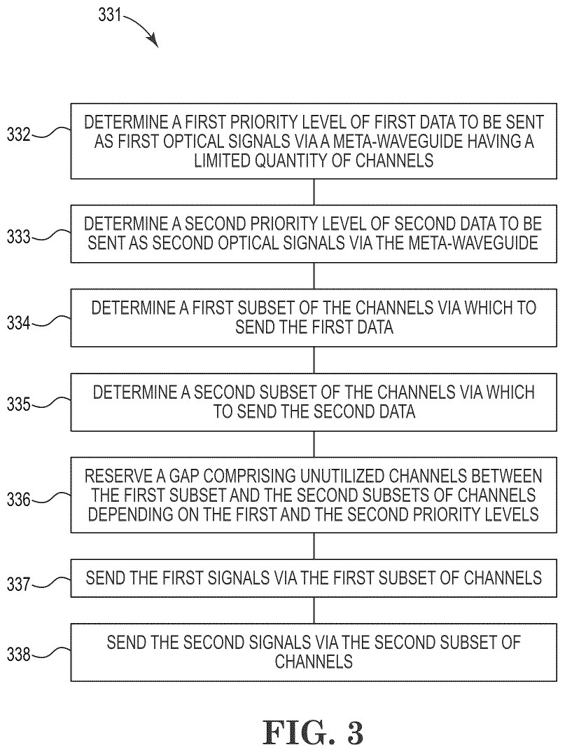

FIG. 3 is a flow diagram illustrating a method 331 for using a channel management tool in accordance with some embodiments of the present disclosure. The method 331 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. As an example, the method 331 can be performed by the processing device 117 previously described in connection with FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible, with reduced crosstalk the higher priority level

At block 332, the method 331 can include determining a first priority level of the first data to be sent as the first optical signals via a meta-waveguide having a limited quantity of channels. In some embodiments, before a controller causes data to be sent through a meta-waveguide, the controller may assess the type of data being sent. That is, the controller can first determine the priority level of the data to determine the best means of conveying the signal through the meta-waveguide. For example, if the data has a high priority the controller can focus on sending the signal through the meta-waveguide in a manner that reduces crosstalk.

At block 333, the method 331 can include determining a second priority level of the second data to be sent as the second optical signals via the meta-waveguide. In some embodiments, the controller can determine the priority level of second data and compare the priority of the second data to the priority level of the first data. The controller can use the priority level of the first data and the second data to determine the location of the corresponding signal on the channel of the meta-waveguide. For example, as described herein, the controller may cause the signal to be sent through the channel with reduced crosstalk at the higher priority level by increasing the quantity of unused channels between other signals. Conversely, if the data has a low priority, the controller may not attempt to reduce crosstalk.

At block 334, the method 331 can include determining a first subset of the channels via which to send the first data. In some embodiments, based on the priority level the controller can cause a subset of channels, including one or more channels, to be dedicated to sending the first data through the meta-waveguide. As described herein, the controller can use the channels included in the subset of channels to reduce the crosstalk when sending the optical signal indicative of the first data.

Similarly, at block 335, the method 331 can include determining a second subset of the channels via which to send the second data. In some embodiments, determining the second subset of the channels can include constraining a quantity of the second subset of channels relative to a quantity of the first subset of channels in response to the first priority level being higher than the second priority level. The controller can cause a subset of channels, including one or more channels, to be dedicated to sending the second data through the meta-waveguide.

At block 336, the method 331 can include reserving a gap comprising unutilized channels between the first subset and the second subset of channels depending on the first and the second priority levels. In some embodiments, the first subset of channels and the second subset of channels can include utilized and unutilized channels. The respective quantity of the channels reserved as unutilized to create the gaps in the first subset of channels and the second subset of channels can be based on a first priority level and a second priority level. The respective quantity of unutilized channels comprising the gaps for the first subset of channels and the second subset of channels can be different if the first priority level is different from the second priority level. For instance, if the first data comprised automotive safety data and the second data comprised infotainment data, the priority levels of the first data and the second data are different and the gap for each data can be set accordingly. The optical signal indicative of the first data can be sent through one or more channels of the first subset of channels depending on the priority level and the amount of data in the first data. Similarly, depending on the priority level and the amount of data in the second data, the optical signal indicative of the second data can be sent through one or more channels of the second subset of channels. The remaining channels in the first subset of channels may be unutilized channels reserved for creating a gap between the utilized channels of the first subset of channels and the utilized channels of the second subset of channels.

The second subset of data can contain channels that are utilized and unutilized. The utilized channels of the second subset of channels may be separated from utilized channels of another subset (e.g., first subset) of channels. For example, the unutilized channels of the second subset of channels may be reserved to create a gap between utilized channels of the first subset of channels and/or may be reserved to create a gap between utilized channels of another subset of channels (e.g., a third subset of channels). In some embodiments, the number of unutilized channels between utilized channels in the first subset of channels and utilized channels in the second subset of channels depends on the priority level of the first data and the second data. For instance, data with a higher priority level may have a gap with more unutilized channels than data with a lower priority level. For example, if first data had the highest priority compared to second data and third data and the second data and the third data had the same priority level, the reserved gap of unutilized channel between the first data and the second data may be larger than the reserved gap of unutilized channel between the second data and the third data. The size of the gap may correlate to the priority level of the data.

At block 337, the method 331 can include sending the first signal via the first subset of channels. At block 338, the method 331 can include sending the second signal via the second subset of channels. Once the priority level of the data is established and a gap based on the priority level has been set, the optical signal indicative of the first data can be sent through the utilized channels of the first subset of channels and the optical signal indicative of the second data can be sent through the utilized channels of the second subset of channels.

FIG. 4 illustrates an example of a system including a computing system 400 in a vehicle 412 in accordance with some embodiments of the present disclosure. The computing system 400 can include a host 420, a memory sub-system 410, which is illustrated as including a controller 415, and non-volatile memory device 430 for simplicity, but is generally analogous to the memory sub-system 110 illustrated in FIG. 1. The host 420, and thus the computing system 400, can be coupled to a number of automotive data sources (e.g., sensors 444) either directly, as illustrated for the sensor 444-1 or via a transceiver 442 as illustrated for the sensors 444-2, 444-3, 444-4, . . . , 444-A. The transceiver 442 is able to receive time based telemetric sensor data from the sensors 444 wirelessly, such as by radio frequency communication. In at least one embodiment, each of the sensors 444 can communicate with the computing system 400 wirelessly via the transceiver 442. In at least one embodiment, each of the sensors 444 is connected directly to the host 420 (e.g., via wires or optical cables). As used herein, the term “telemetric sensor data” refers to data that is collected by sensors 444 that are remote from the memory sub-system 410 that stores the data (the receiving equipment).

Each of the vehicles 412 can include an advanced driver assistance system (ADAS). In some embodiments, an ADAS can include a memory device 430, a transceiver 442 configured to communicate with sensors 444 and host 420 and a controller 415 coupled to the memory device 430. The vehicle 412 can be a car (e.g., sedan, van, truck, etc.), a connected vehicle (e.g., a vehicle that has a computing capability to communicate with an external server), an autonomous vehicle (e.g., a vehicle with self-automation capabilities such as self-driving), a drone, a plane, a ship, and/or anything used for transporting people and/or goods. The sensors 444 illustrated in FIG. 4 can include example attributes. For example, sensor 444-1 can be a navigation sensor, such as a global positioning system (GPS) receiver. Sensor 444-2 can be a microphone or camera sensor collecting data from the front of the vehicle 412 or a speedometer. As another example, the sensors 444-4 and 444-A can be tire pressure sensors. As another example, the sensors 444 can represent a number of engine sensors such as a temperature sensor, a pressure sensor, a voltmeter, an ammeter, a tachometer, a fuel gauge, etc. As another example, the sensors 444 can represent a video camera.

The ADAS can also include a host 420 coupled to the computing system 400. The host 420 through channel management circuitry can be connected to a meta-waveguide comprising a plurality of channels 428. The channels 428 can be coupled to the controller 415, memory sub-system 410, and the memory device 430 through the host 420 including the channel management circuitry. The host 420 can execute instructions to provide an overall control system and/or operating system for the vehicle 412. In some embodiments, the host 420 can include a channel management circuitry designed to assist in channel allocation when systems (e.g., sensors 444, computing system 400, controller 415, memory device 430) of the vehicle 412 communicate with each other. The host 420, through the channel management circuitry, can monitor communication channels and data and send data from the sensors 444 to the memory sub-system 410 through appropriate channels to prevent crosstalk, as discussed herein. For example, the host 420 can receive data from the sensors 444 in the vehicle 412 and allocate channels and/or subset of channels to send the data to the memory sub-system 410. The host 420 can cause the channel management circuitry to send an optical signal to the memory sub-system 410, controller 415, and/or the memory device 430 through selected channels 428. The channel management circuitry can use the priority level, function, and size of the data to determine which channels 428 to allocate to data. Similarly, the host, via the channel management circuitry, can allocate channels 428 to send data to other systems in the vehicle 412. For example, the host 420 can receive data from a first sensor 444-1 and allocate channels 428 to send the data to another sensor 444-2. The priority level of data received by a plurality of sources (e.g., sensors 444) can be determined by the channel management circuitry. For instance, the host 420 can receive data from a first sensor 444-1 and a second sensor 444-2 and determine the priority level and function of the data received to determine the subset of channels for each data.

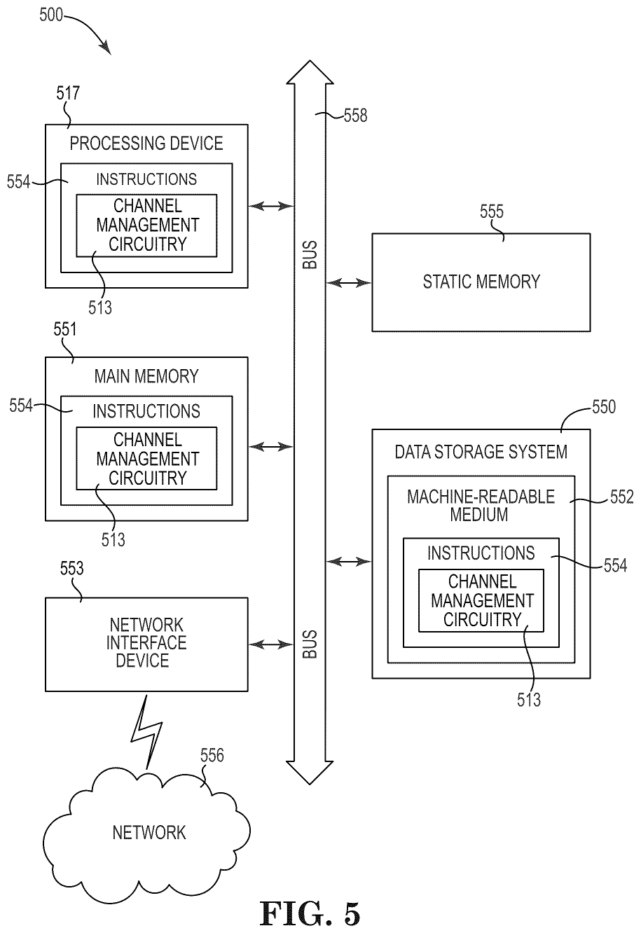

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 in FIG. 1) that includes, is coupled to, or utilizes a memory sub-system (e.g., the memory sub-system 110 in FIG. 1) or can be used to perform the operations of a controller (e.g., to execute an operating system to perform operations corresponding to the channel management circuitry 213 illustrated in FIG. 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a vehicle, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 517, a main memory 551 (e.g., read-only memory (ROM), flash memory, dynamic random access memory (DRAM) such as synchronous DRAM (SDRAM) or Rambus DRAM (RDRAM), etc.), a static memory 555 (e.g., flash memory, static random access memory (SRAM), etc.), and a data storage system 550, which communicate with each other via a bus 558.

The processing device 517 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 517 can also be one or more special-purpose processing devices such as an application specific integrated circuit (ASIC), a field programmable gate array (FPGA), a digital signal processor (DSP), network processor, or the like. The processing device 517 is configured to execute instructions 554 for performing the operations and steps discussed herein. The computer system 500 can further include a network interface device 553 to communicate over the network 556.

The data storage system 550 can include a machine-readable storage medium 552 (also known as a computer-readable medium) on which is stored one or more sets of instructions 554 or software embodying any one or more of the methodologies or functions described herein. The instructions 554 can also reside, completely or at least partially, within the main memory 551 and/or within the processing device 517 during execution thereof by the computer system 500, the main memory 551 and the processing device 517 also constituting machine-readable storage media. The machine-readable storage medium 552, data storage system 550, and/or main memory 551 can correspond to the memory sub-system 110 in FIG. 1.

In one embodiment, the instructions 554 include instructions to implement functionality corresponding to channel management 513 (e.g., channel management circuitry 113 in FIG. 1). While the machine-readable storage medium 552 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of a number of embodiments of the present disclosure. It is to be understood that the above description has been made in an illustrative fashion, and not a restrictive one. Combination of the above embodiments, and other embodiments not specifically described herein will be apparent to those of ordinary skill in the art upon reviewing the above description. The scope of a number of embodiments of the present disclosure includes other applications in which the above structures and methods are used. Therefore, the scope of a number of embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An optical communication system comprising:
an optical source configured to send optical signals;
a meta-waveguide having a limited quantity of channels, the meta-waveguide coupled to the optical source and configured to transport the optical signals; and
a controller coupled to the optical source and the meta-waveguide, the controller configured to:
determine a type of data to be sent via the meta-waveguide;
cause optical signals indicative of the data to be sent through at least one of the channels; and
cause a gap comprising at least one unutilized channel to be reserved between the at least one channel and another utilized channel depending on the type of data.

2. The optical communication system of claim 1, wherein the controller is further configured to assign a subset of the channels to a specified function.

3. The optical communication system of claim 2, wherein the controller is further configured to:
assign each of a plurality of subsets of the channels to a respective function; and
cause a different gap to be reserved between each of the plurality of subsets of the channels depending upon a respective type of data associated with the respective function.

4. The optical communication system of claim 1, further comprising a micro-ring resonator coupled to the meta-waveguide and to the controller;
wherein the controller is configured to operate the micro-ring resonator to reserve the gap.

5. The optical communication system of claim 1, wherein the gap comprises a quantity of the channels dependent upon the type of data.

6. The optical communication system of claim 1, wherein the controller is configured to:
cause first optical signals indicative of a first type of data to be sent through a first channel;
cause second optical signals indicative of a second type of data to be sent through a second channel;
cause third optical signals indicative of a third type of data to be sent through a third channel;
cause a first gap to be employed between the first channel and the second channel; and
cause a second gap to be employed between the second channel and the third channel, wherein a relative size of the first gap to the second gap is based on a relative importance of the first type of data, the second type of data, and the third type of data.

7. The optical communication system of claim 6, wherein the channels comprise sub-carrier channels.

8. The optical communication system of claim 1, wherein the controller is configured to cause the gap to comprise every unutilized channel.

9. An optical communications method comprising:
determining a first priority level of first data to be sent as first optical signals via a meta-waveguide having a limited quantity of channels;
determining a second priority level of second data to be sent as second optical signals via the meta-waveguide;
determining a first subset of the channels via which to send the first data;
determining a second subset of the channels via which to send the second data;
reserving a gap comprising unutilized channels between the first subset and the second subset of the channels depending on the first and the second priority levels;
sending the first signals via the first subset of the channels; and
sending the second signals via the second subset of the channels.

10. The method of claim 9, wherein reserving the gap comprises reserving a quantity of the channels as unutilized based on the first priority level and the second priority level.

11. The method of claim 9, wherein determining the second subset of the channels comprises constraining a quantity of the second subset of the channels relative to a quantity of the first subset of the channels in response to the first priority level being higher than the second priority level.

12. The method of claim 11, wherein the first data comprises automotive safety data;
wherein the second data comprises infotainment data; and
wherein the method is performed by an advanced driver assistance system.

13. The method of claim 12, further comprising using a micro-ring resonator to reserve the gap.

14. The method of claim 9, wherein the gap comprises each unutilized channel of the meta-waveguide; and
wherein the channels comprise sub-carrier channels of the meta-waveguide.

15. An advanced driver assistance system (ADAS), comprising:
a memory device;
a plurality of automotive data sources;
a meta-waveguide comprising a plurality of channels coupled to the memory device; and
a controller coupled to the memory device, the plurality of automotive data sources, and to the meta-waveguide, wherein the controller is configured to:
determine a priority level of data received from the plurality of automotive data sources;
reserve a gap comprising at least one unutilized channel between a first channel used to exchange a first type of data with the memory device and a second channel used to exchange a second type of data with the memory device, depending on a first priority level of the first type of data and a second priority level of the second type of data;
exchange the first type of data with the memory device via the first channel; and
exchange the second type of data with the memory device via the second channel.

16. The ADAS of claim 15, wherein the controller is configured to allocate a first quantity of channels to be used to exchange the first type of data based on the first priority level; and
allocate a second quantity of channels to be used to exchange the second type of data based on the second priority level.

17. The ADAS of claim 16, wherein the controller is configured to prioritize crosstalk reduction provided by the gap over bandwidth provided by the first quantity of channels and the second quantity of channels.

18. The ADAS of claim 16, wherein the first type of data is received from a first automotive data source related to a first function of the ADAS; and
wherein the second type of data is received from a second automotive data source related to a second function of the ADAS.

19. The ADAS of claim 16, wherein the second quantity of channels is lesser than the first quantity of channels; and
wherein the second type of data has a lower priority than the first type of data.

20. The ADAS of claim 15, wherein the channels comprise sub-carrier channels of the meta-waveguide.
